(19) United States
(12) Patent Application Publication
(10) Pub. No.: US 2024/0421472 A1
(43) Pub. Date: Dec. 19, 2024

(54) ANTENNA MODULE AND ELECTRONIC DEVICE COMPRISING SAME

(71) Applicant: LG INNOTEK CO., LTD., Seoul (KR)

(72) Inventors: Tae Gyeong JANG, Seoul (KR); Yu Seon KIM, Seoul (KR); II Hee PARK, Seoul (KR); Youn Ung JEONG, Seoul (KR)

(21) Appl. No.: 18/722,180

(22) PCT Filed: Dec. 21, 2022
(86) PCT No.: PCT/KR2022/020965

§ 371 Date: Jun. 20, 2024

(30) Foreign Application Priority Data
Dec. 21, 2021 (KR) 10-2021-0184398

(51) Int. Cl. H01Q 1/52; H01Q 5/20; H01Q 9/04

(52) U.S. Cl. CPC H01Q 1/521; H01Q 5/20; H01Q 9/0414

(57) ABSTRACT

An antenna module, according to one embodiment of the present invention, comprises: a first radiation unit disposed on a substrate and having a current applied thereto through a first feed pattern; and a second radiation unit disposed on the substrate so as to be spaced from the first radiation unit, and having a current applied thereto through a second feed pattern, wherein respective signals radiated by the first radiation unit and the second radiation unit have mutually different phases.

### TECHNICAL FIELD

The present invention relates to an antenna module, and more specifically, to an antenna module that excludes signal interference by implementing a phase difference between antennas using a feeding pattern, and an electronic device comprising the same.

### BACKGROUND ART

As devices being connected to the outside, such as TVs or monitors, become more diverse, the need for wireless communication modules that enable various types of communication, such as Wi-Fi and Bluetooth, rather than just one communication method, is increasing. To this end, a plurality of antennas for each communication method is applied to one communication module.

As the thickness of TVs tends to become thinner, the mounting position and space of the wireless communication module are narrow and limited, and accordingly, the design of the ultra-small wireless communication module is required. When the size of the wireless communication module is reduced, mutual signal interference increases as the separation distance between antennas approaches, and accordingly, when Wi-Fi and Bluetooth are used at the same time, there is a problem that wireless transmission performance is deteriorated or Bluetooth sound quality is deteriorated.

### DETAILED DESCRIPTION OF THE INVENTION

### Technical Subject

The technical problem to be solved by the present invention is to provide an antenna module that excludes signal interference by implementing a phase difference between antennas using a feed pattern, and an electronic device comprising the same.

The problems of the present invention are not limited to the problems mentioned above, and other problems not mentioned will be clearly understood by those skilled in the art from the following description.

### Technical Solution

In order to solve the above technical problem, the antenna module according to an embodiment of the present invention comprises: a first radiation unit being disposed on a substrate and being applied with a current through a first feed pattern; and a second radiation unit being disposed on the substrate being spaced apart from the first radiation unit and applied with a current through a second feed pattern, wherein the phases of signals being radiated by the first radiation unit and the second radiation unit are different.

In addition, the first radiation unit and the second radiation unit may have a phase difference of 90 degrees.

In addition, the substrate includes a plurality of layers, wherein the first feed pattern includes: an input end and an output end; and a first pattern unit connecting between the input end and the output end, and wherein the first pattern unit may be formed on at least some of the plurality of layers of the substrate.

In addition, first pattern units being formed on the plurality of layers of the substrate may be connected to one another through a via hole being formed at the input end and the output end.

In addition, the substrate includes four layers, and the first pattern unit may be formed on the four layers and connected to one another in parallel.

In addition, the length of the first pattern unit being connected between the input end and the output end may be 4.5 to 6.5 mm.

In addition, the substrate includes a plurality of layers, and the second feed pattern comprises: an input end and an output end; a second pattern unit connecting the input end and the output end and being formed on some of the plurality of layers of the substrate; and a third pattern unit not being connected to the input end and the output end and being formed on a layer different from the second pattern unit among the plurality of layers of the substrate.

In addition, the third pattern unit may be formed on an upper side and a lower side of the layer where the second pattern unit is formed.

In addition, the third pattern units being formed on an upper side and a lower side of the layer where the second pattern unit is formed may be connected to one another through a via hole.

In addition, the length of the second pattern unit being connected between the input end and the output end may be 8.2 to 10.2 mm.

In addition, the second pattern unit may be formed in a meander shape.

In addition, the substrate includes four layers, wherein the second pattern unit includes: a second layer pattern being formed in the second layer and connected to the input end and the output end through a via hole; and a fourth layer pattern being formed in the fourth layer and connected to the central area of the second layer pattern unit through a via hole, and wherein the third pattern unit may include: a first layer pattern being formed in the first layer and not being electrically connected to the input end and the output end; and a third layer pattern being connected to the first layer pattern unit through a via hole and formed in the third layer.

In addition, the third pattern unit may be spaced apart from the second pattern unit to form capacitance.

In addition, the length of a radiation patch of the first radiation unit may be 12.8 to 13.2 mm.

In addition, the first radiation unit includes a first radiation patch and a second radiation patch, wherein the length of the first radiation patch is 12.8 to 13.2 mm, and wherein the length of the second radiation patch may be 3.8 to 4.2 mm.

In addition, the length of the radiation patch of the second radiation unit may be 13.8 to 14.2 mm.

In addition, one of the first radiation unit and the second radiation unit may be a radiation unit for Wi-Fi, and the other may be a radiation unit for Bluetooth.

In addition, it includes a third radiation unit being disposed on the substrate and spaced apart from the first radiation unit and the second radiation unit, wherein the phase of a signal being radiated from the third radiation unit may be different from that of the first radiation unit and the second radiation unit.

In addition, the third radiation unit may have a phase difference of 90 degrees from the first radiation unit, and a phase difference of 180 degrees from the second radiation unit.

In order to solve the above technical problem, an electronic device according to an embodiment of the present invention includes one antenna module among the antenna modules described above.

### Advantageous Effects

According to embodiments of the present invention, signal interference between Wi-Fi and Bluetooth antennas can be minimized in an ultra-small module even if they are adjacent to one another. Through this, wireless Wi-Fi transmission rate can be secured when operating simultaneously with Bluetooth. Furthermore, despite being an ultra-small module, two types of PIFA antennas can radiate with sufficient radiation efficiency.

The effect according to the invention is not limited by the contents exemplified above, and more various effects are included in the present specification.

### BRIEF DESCRIPTION OF DRAWINGS

FIG. 1 illustrates an antenna module according to an embodiment of the present invention.

FIGS. 2 to 14 are diagrams for explaining each configuration of an antenna module according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

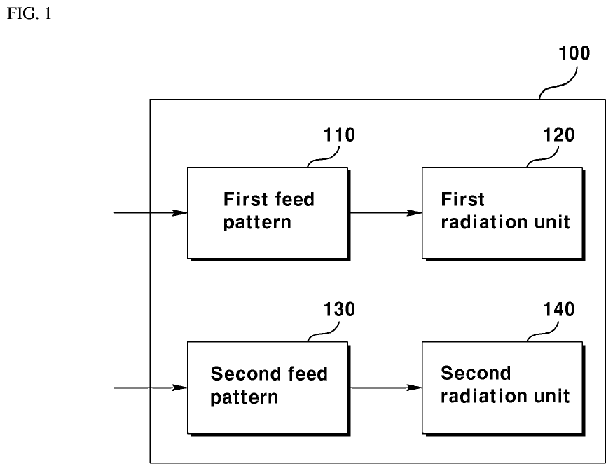

FIG. 1 illustrates an antenna module according to an embodiment of the present invention.

The antenna module 100 according to an embodiment of the present invention comprises a substrate 150, a first feed pattern 110, a first radiation unit 120, a second feed pattern 130, and a second radiation unit 140, wherein a third radiation unit 160 and a communication module chip 170 may be included.

The first radiation unit 120 is applied with a current through the first feed pattern 110; the second radiation unit 140 is applied with a current through the second feed pattern 130; and signals with different phases from one another are radiated.

The first radiation unit 120 and the second radiation unit 140 are disposed on the substrate 150; a current is applied through feed lines including the first feed pattern 110 and the second feed pattern 130, respectively; and according to the applied current, signals each having a predetermined frequency band are radiated to the outside. At this time, they are implemented in a way that the phase of each of the signals being radiated is different due to passing through the first radiation unit 120 and the second radiation unit 140. For example, the first radiation unit 120 and the second radiation unit 140 may have a phase difference of 90 degrees. Through this, orthogonality between the two signals can be achieved, thereby minimizing interference between them. Alternatively, it may be formed to have a phase difference of 180 degrees or a phase difference of less than 90 degrees. A phase difference is implemented in a way that signal interference is reduced below the threshold, or it may be formed to implement the maximum phase difference in the specifications of the module.

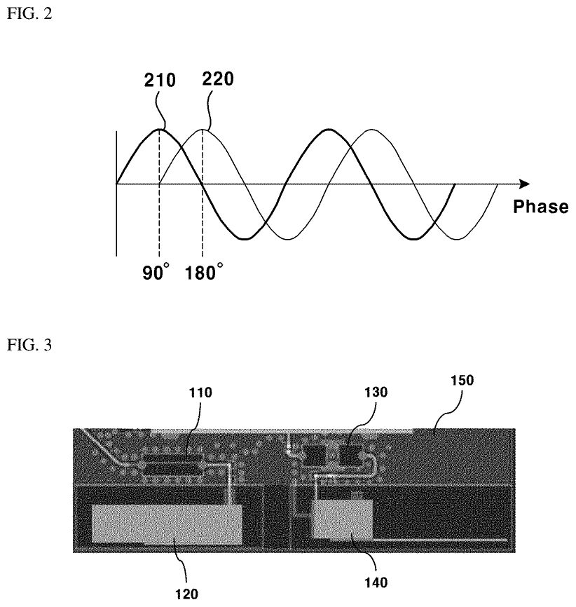

In order to ensure that the radiation signals of the first radiation unit 120 and the second radiation unit 140 have a phase difference of 90 degrees, as shown in FIG. 2, the first feed pattern 110 is formed so that the signal 210 radiated from the first radiation unit 120 has a phase of 90 degrees, and the second feed pattern 130 may be formed so that the signal 220 radiated from the second radiation unit 140 has a phase of 180 degrees. Alternatively, it is formed in a way that the first radiation unit 120 has a phase of 0 degree and the second radiation unit 140 has a phase of 90 degrees or 270 degrees, or it may be formed in a way that the first radiation unit 120 has a phase of 180 degrees and the second radiation unit 140 has a phase of 90 degrees or 270 degrees. It can be implemented in various embodiments depending on the phase difference to be implemented.

As shown in FIG. 3, since the first radiation unit 120 and the second radiation unit 140 adjacent to one another may cause signal interference to one another, it may be formed to have a phase difference using the first feed pattern 110 and the second feed pattern 130.

In order to implement the first radiation unit 120 to have a phase of 90 degrees based on the radiation signal when it does not include the first feed pattern 110, the first feed pattern 110 may include an input end 111, an output end 112, and a first pattern unit 113.

Here, the substrate 150 may include a plurality of layers, and the first pattern unit 113 may be formed on at least some of the plurality of layers of the substrate 150.

The first feed pattern 110 can implement a change in phase by forming a long feed pattern, and to this end, a first pattern unit 113 capable of increasing the length of the feed pattern may be included. The feed line may be mounted on an upper surface, which is the first layer of the substrate, and due to miniaturization of antenna modules, the space where the first feed pattern can be formed is narrow, it may be difficult to implement a phase difference of 90 degrees using only the pattern in the first layer. The substrate 150 may include a plurality of layers, and required length of the feed pattern can be secured by forming the first pattern unit 113 on a plurality of layers among the plurality of layers of the substrate. At this time, the first pattern unit 113 being formed in the plurality of layers of the substrate 150 may be connected to one another through via holes formed in the input end 111 and the output end 112. The first pattern unit 113 being formed in each layer is connected through via holes at the input end 111 and the output end 112, so that the feed patterns of each layer can be connected in parallel.

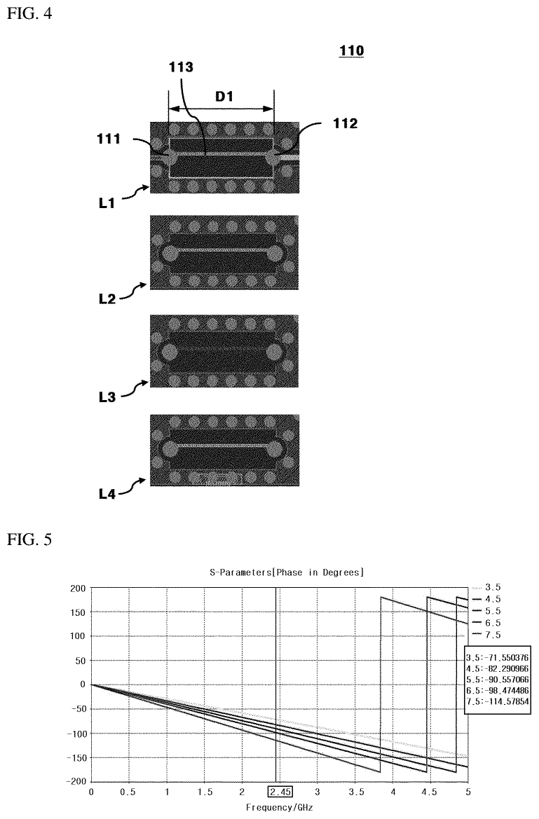

For example, the substrate 150 includes four layers, and the first pattern unit 113 may be formed on the four layers and connected to one another in parallel. As shown in FIG. 4, when the substrate 150 includes four layers (L1 to L4), the feed pattern of the first pattern unit 113 may be formed in each layer to form a long feed pattern, and through this, it can be implemented to have a phase of 90 degrees. The input end 111 and the output end 112 are connected with the first pattern unit 113, and a feed pattern is formed on each of the four layers of the first pattern unit 113, and then they can be connected in parallel by connecting through via holes. The via holes are electrically connected to the input end 111 and the output end 112, and feed line, and may be formed to be spaced apart from other metal forming portions of the substrate.

The length of the first pattern unit 113 being connected between the input end 111 and the output end 112 is derived so that the signal being radiated from the first radiation unit 120 has a phase of 90 degrees, and the corresponding length can be set to the length of the first pattern unit 113. The length of the first pattern unit 113 being connected between the input end 111 and the output end 112 may be 4.5 to 6.5 mm. At this time, the phase may have 80 to 100 degrees.

FIG. 5 shows the phase according to the length of the first pattern unit 113 being connected between the input end 111 and the output end 112, in order to derive a length having a phase of 90 degrees at the resonant frequency of the first radiation unit 120, and as a result of applying different lengths, it can be confirmed that it has a phase of 90 degrees at about 5.5 mm between 4.5 and 6.5 mm. In securing the corresponding length, FIG. 4 shows an embodiment being formed with straight lines, but it is natural that it can have various pattern shapes other than straight lines, such as a diagonal shape or a meander shape. In addition, the first pattern unit 113 can be implemented using only two or three of the four layers without forming a feed pattern on all four layers.

In order to implement a phase difference of 180 degrees based on the radiation signal when the second radiation unit 140 does not include the second feed pattern 130 so as to have a phase difference with the first radiation unit 120, the second feed pattern 130 may include an input end 131, an output end 132, a second pattern unit 133, and third pattern units 134 and 135. Here, the substrate 150 may include a plurality of layers, and the second pattern unit 133 and the third pattern units 134 and 135 may be formed in different layers among the plurality of layers of the substrate 150. The second pattern unit 133 connects the input end 131 and the output end 132 and may be formed on some of the plurality of layers of the substrate 150, and the third pattern units 134 and 135 may be formed on a layer different from the second pattern unit 133 among the plurality of layers of the substrate 150 without being connected to the input end 131 and the output end 132.

In order to implement a phase of 180 degrees, which has a larger phase than the first feed pattern 110 that implements a phase of 90 degrees, the second feed pattern 130 is not connected to the second pattern unit 133, but not electrically connected to the second pattern unit 133 as well, but may include third pattern units 134 and 135 capable of forming a coupling. To this end, the third pattern units 134 and 135 may be formed on an upper side and a lower side of the layer where the second pattern unit 133 is formed. The third pattern units 134 and 135 may form capacitance by being formed on an upper side and a lower side of the second pattern unit 133. By forming a capacitance, the second feed pattern can form a coupling structure, thereby implementing a phase change greater than that of the first feed pattern 110. At this time, the third pattern units 134 and 135 being formed on an upper side and a lower side of the layer where the second pattern unit 133 is formed may be connected to one another through a via hole. Since the second pattern unit 133 should not be electrically connected to the via hole where the third pattern units 134 and 135 are connected, in order to avoid connection with the second pattern unit 133, via holes may be formed to be spaced apart in a direction perpendicular to the lengthwise direction of the second pattern unit 133.

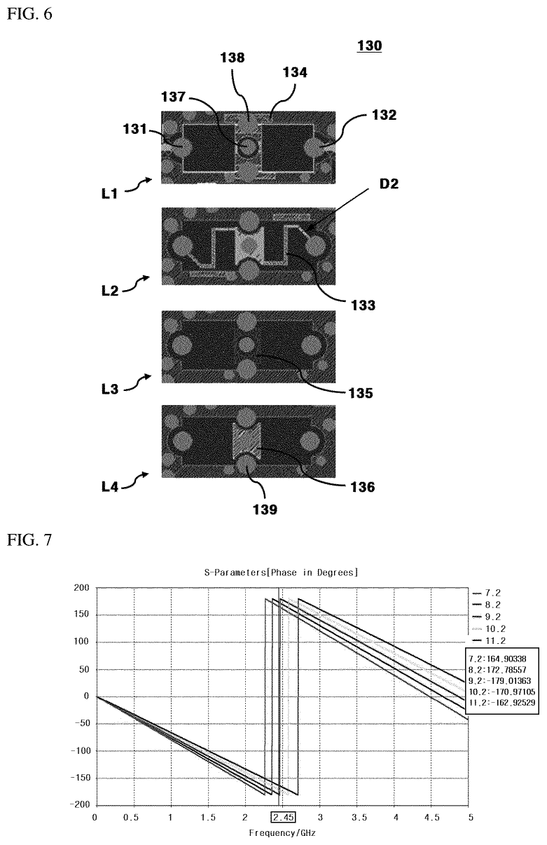

For example, the substrate 150 includes four layers, wherein the second pattern unit 133 includes a second layer pattern 133 and a fourth layer pattern 136, wherein the second layer pattern 133 is connected to the input end 131 and the output end 132 through a via hole and formed in the second layer, wherein the fourth layer pattern 136 is connected to the central area of the second layer pattern 133 through a via hole 137, and formed on the fourth layer, wherein the third pattern units 134 and 135 includes a first layer pattern 134 and a third layer pattern 136, wherein the first layer pattern 134 is not electrically connected to the input end 131 and the output end 132, and formed in the first layer, and wherein the third layer pattern 135 is connected to the first layer pattern 134 through via holes 138 and 139 and formed in the third layer. As shown in FIG. 6, the substrate 150 includes first to fourth layers (L1 to L4), wherein the second pattern unit 133 includes a second layer pattern 133 and a fourth layer pattern 136, and wherein the third pattern units 134 and 135 may include a first layer pattern 134 and a third layer pattern 135. Here, in a first layer to a fourth layer, the first layer is an upper layer, that is, the uppermost layer of the substrate where the feed line is disposed, and the fourth layer may be the lowest layer. The second layer pattern 133, which is the second pattern unit 133, is connected to the input end 131 and the output end 132 through a via hole, and connected to the fourth layer pattern 136 through the via hole 137 in the central area. The fourth layer pattern 136 is not directly connected to the input end 131 and the output end 132, but is shown to be connected to the second layer pattern 133 through the via hole 137 in the central area, but it may also be implemented to be directly connected to the input end 131 and the output end 132 through a via hole.

The first layer pattern 134 and third layer pattern 135 are formed to be spaced apart from the via hole 137 in the central area so as not to be connected to the input end 131, the output end 132, the second layer pattern 133, or the fourth layer pattern 136, and can be connected to one another through two via holes 138 and 139 being formed at both sides of the via hole 137 in the central area. The second layer pattern 133 and the fourth layer pattern 136 are formed to be spaced apart from the two via holes 138 and 139.

The length of the second pattern unit 133 being connected between the input end 131 and the output end 132 is derived so that the signal being radiated from the first radiation unit 120 has a phase of 180 degrees, and the corresponding length can be set to the length of the second pattern unit 133. The length of the second pattern unit 133 being connected between the input end 131 and the output end 132 may be 8.2 to 10.2 mm.

In order to implement this with a length longer than the length of the first pattern unit 113 described above, the second pattern unit 133 may be formed in a meander shape. In addition, the total length of the second pattern unit 133 may be implemented in various forms to implement the corresponding length.

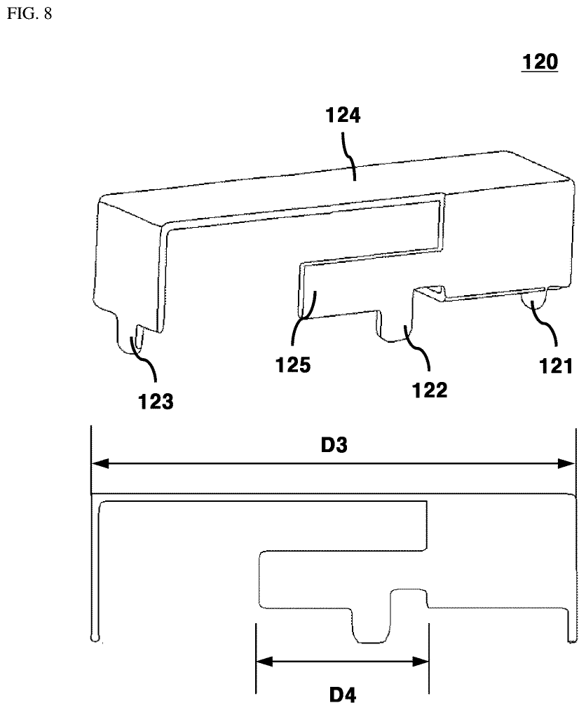

FIG. 7 shows the phase according to the length of the second pattern unit 133 being connected between the input end 131 and the output end 132, in order to derive a length having a phase of 180 degrees at the resonant frequency of the second radiation unit 140, and as a result of applying different lengths, it can be confirmed that it has a phase of 180 degrees at about 8.2 mm between 8.2 and 10.2 mm. At this time, the phase may have 170 degrees to 190 degrees.

The length may be the shortest length implemented by the second pattern unit 133. In securing the relevant length, FIG. 6 illustrates an embodiment formed in a meander shape, but it is natural that it can have various pattern shapes other than the meander shape, such as a straight line shape or a diagonal shape. In addition, the second pattern unit 133 may be implemented using only the second layer, without forming a feed pattern in both the second layer and the fourth layer.

In addition to the first radiation unit 120 and the second radiation unit 140, it may include a radiation unit that radiates another signal. It includes a third radiation unit 160 being disposed on the substrate 150 and spaced apart from the first radiation unit 120 and the second radiation unit 140, wherein the phase of the signal radiating from the third radiation unit 160 may be different form that of the first radiation unit 120 and the second radiation unit 140. At this time, the third radiation unit 160 has a phase difference of 90 degrees with the first radiation unit 120 and may have a phase difference of 180 degrees with the second radiation unit 140. When including the third radiation unit 160, each of the signal interferences can be minimized by implementing in a way that the phase of the first radiation unit 120 is to be 90 degrees and the phase of the second radiation unit 140 is to be 180 degrees, respectively, based on the phase of 0 degrees of the third radiation unit 160. When the third radiation unit 160 is adjacent to the first radiation unit 120, adjacent radiation units have orthogonality with one another, thereby minimizing interference with one another. Alternatively, the first feed pattern 110 and the second feed pattern 130 may be implemented to have a phase difference other than 90 degrees, for example, 120 degrees.

For various communications, a plurality of radiation units having various frequency bands may be formed in one antenna module. In particular, for short-distance communication, a radiation unit for Wi-Fi, Bluetooth, GPS, or NFC may be required. In the case of a smart TV, Wi-Fi and Bluetooth are essential for data transmission and reception between the TV and a router or mobile terminal, and an antenna module being formed with a radiation unit for the communication is required.

One of the first radiation unit 120 and the second radiation unit 140 may be a Wi-Fi radiation unit, and the other may be a Bluetooth radiation unit. Alternatively, it may be radiation for other communications, such as a radiation unit for NFC. Here, the first radiation unit 120 may be a Wi-Fi radiation unit. To this end, the first radiation unit 120 may cause resonance in at least one of the Wi-Fi frequency band of 2.4 to 2.5 GHz or 5.0 to 5.2 GHz. The second radiation unit 140 may be a radiation unit for Bluetooth. To this end, the second radiation unit 140 may cause resonance in the 2.4 to 2.5 GHz band, which is the Bluetooth frequency band.

The first radiation unit 120 may include a radiation patch, at least one feed portion, and at least one support portion. As an embodiment, as shown in FIG. 8, the first radiation unit 120 may include radiation patches 124 and 125, at least one feed portion 121, and at least one of support portions 122 and 123. It includes a radiation patch 124 that radiates a signal, and can be connected to the substrate 150 through a feed portion 121 that receives a current from the substrate 150. The radiation patch 124 is formed to be spaced apart from the substrate 150 at a predetermined interval, and may include support portions 122 and 123 for supporting the radiation patch 124, being formed to be spaced apart from the substrate 150. The configuration described as a feed portion and the configuration described as a support portion may be configured as a feed portion or a support portion depending on whether or not it is connected to the feed line of the substrate 150. This may vary depending on the radiation unit design.

The first radiation unit 120 may be a PIFA antenna. PIFA is a planar inverted F antenna, and means a flat antenna with a square patch plate of a smaller area placed on the ground plane of the flat plate as if F was flipped upside down. It may be configured with a ground plane, a radiation patch, a feed portion, and a shorting portion (shorting pin or shorting strip). The PIFA antenna acts as a radiating element as the patch resonates with the ground plane due to feeding of current. Bandwidth, gain, resonance frequency, and the like can be determined depending on the length, width, and height of the patch, the location of the feed line, the location of the shorting pin, and the like. The first radiation unit 120 is not limited to the PIFA antenna, and may naturally be a variety of antennas such as helical antennas, monopole antennas, and SMD antennas.

The characteristics of the first radiation unit 120 are affected by the length D3 and width of the radiation patch 124, the distance between the radiation patch 124 and the substrate 150, and the like, and in particular, it is greatly influenced by the length D3 of the radiation patch 124.

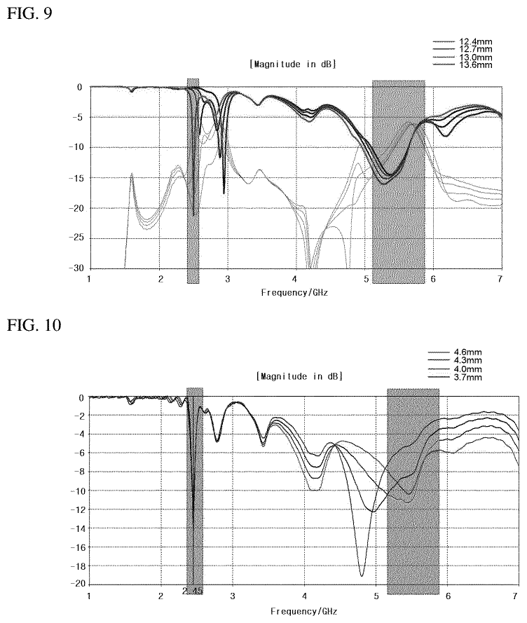

FIG. 9 is a graph showing the reflection loss according to the length D3 of the radiation patch 124, and through this, the length of the radiation patch 124 of the first radiation unit 120, which most resonates at the resonance frequency, is derived, so that the length can be set to the length of the radiation patch 124. Here, the first radiation unit 120 may determine the length at which resonance most occurs in the 2.4 to 2.5 GHz band as the optimal length, and set the length of the first radiation unit 120 to the corresponding length. By setting the variable range to 12.4 to 13.6 mm (unit length: 0.3 mm), it can be confirmed that the resonance frequency varies depending on the length, and that 13.0 mm is the length at which resonance occurs most easily. Considering the error, the length of the radiation patch 124 of the first radiation unit 120 may be 12.8 to 13.2 mm.

The corresponding length represents the length in one embodiment, and it is natural that the shape and length of each component may vary depending on the design.

The first radiation unit 120 may include a first radiation patch 124 and a second radiation patch 125 rather than one radiation patch. The characteristics of the first radiation unit 120 are affected by the length D4 and width of the second radiation patch 125, the distance between the second radiation patch 125, the substrate 150, and the like, and in particular, it is greatly influenced by the length D4 of the second radiation patch 125.

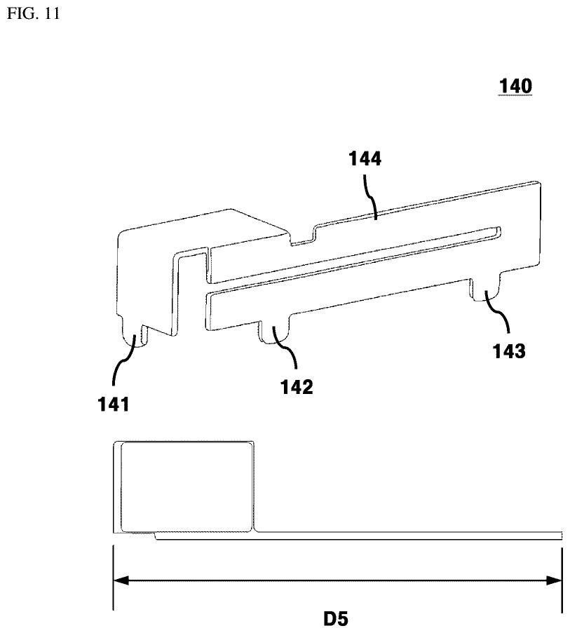

FIG. 10 is a graph showing the reflection loss according to the length D4 of the second radiation patch 125, and through which, the length of the second radiation patch 125 of the first radiation unit 120, which most resonates at the resonance frequency, is derived so that the length can be set to the length of the second radiation patch 125. Here, the first radiation unit 120 determines the length of the second radiation patch 125, where resonance most occurs in the 2.4 to 2.5 GHz band, as the optimal length, so that the length of the second radiation patch 125 can be set to the corresponding length. By setting the variable range to 3.7 to 4.6 mm (unit length: 0.3 mm), it can be seen that the resonance frequency varies depending on the length, and it can be confirmed that the length at which resonance most occurs is 4.0 mm. Considering the error, the length of the second radiation patch 125 of the first radiation unit 120 may be 3.8 to 4.2 mm. The length of the first radiation patch 124 is 12.8 to 13.2 mm; the length of the second radiation patch 125 may be 3.8 to 4.2 mm; the corresponding length represents the length in one embodiment; and it is natural that the shape or length of each component may vary depending on the design.

The second radiation unit 140 may include at least one feed portion of the radiation patch and at least one support portion. As an embodiment, as shown in FIG. 11, the second radiation unit 140 may include a radiation patch 144, at least one feed portion 141, and at least one of support portions 142 and 143. The radiation patch 144 may be connected to the substrate 150 through a feed portion 141 that receives a current from the substrate 150. The feed portion 141 and the radiation patch 144 may be connected, and the radiation patch 144 may be spaced apart from the substrate 150 at a predetermined interval and may be supported by the support portions 142 and 143. The configuration described as a feed portion and the configuration described as a support portion may be configured as a feed portion or a support portion depending on whether or not it is connected to the feed line of the substrate 150. In addition, the radiation patch may also be formed in various shapes and may vary depending on the design of the radiation unit.

The second radiation unit 140 may also be a PIFA antenna. In addition, the second radiation unit 140 is not limited to the PIFA antenna, and may naturally be a variety of antennas such as a helical antenna, a monopole antenna, and an SMD antenna.

The characteristics of the first radiation unit 140 are affected by the length D5 and width of the radiation patch, the distance between the radiation patch and the substrate 150, and the like, and in particular, it is greatly influenced by the length D5 of the radiation patch.

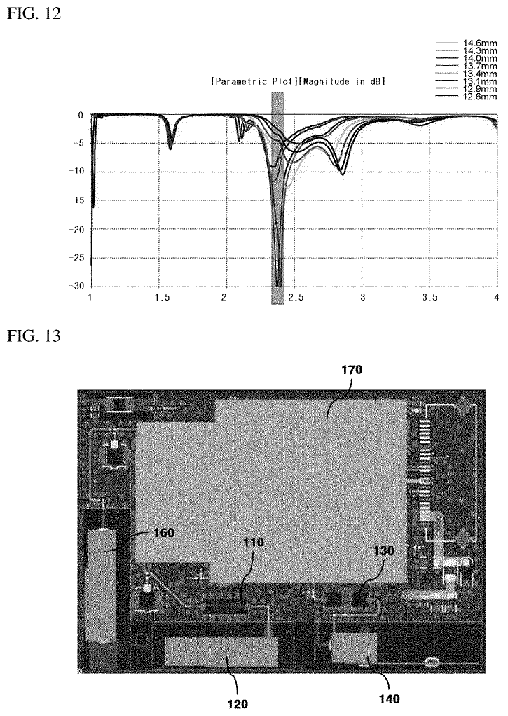

FIG. 12 is a graph showing the reflection loss according to the length D5 of the radiation patch, and through which, the length of the second radiation patch of the second radiation unit 140, which most resonates at the resonance frequency, is derived so that the length can be set to the length of the radiation patch. Here, the second radiation unit 140 determines the length, where resonance most occurs in the 2.4 to 2.5 GHz band, as the optimal length, so that the length of the second radiation unit 140 can be set to the corresponding length. By setting the variable range to 12.6 to 14.6 mm (unit length: 0.3 mm), it can be seen that the resonance frequency varies depending on the length, and it can be confirmed that the length at which resonance most occurs is 4.0 mm. Considering the error, the length of the second radiation unit 140 of the second radiation unit 140 may be 13.8 to 14.2 mm.

The antenna module 100 according to an embodiment of the present invention may further include other radiation units in addition to the first radiation unit 120 and the second radiation unit 140. When the first radiation unit 120 is a Wi-Fi radiation unit, a third radiation unit 160 may be further included in order to increase the radiation characteristics of the Wi-Fi signal. The number and shape of radiation units being formed in the antenna module 100 may vary depending on the design of the antenna module.

The antenna module 100 according to an embodiment of the present invention may further include other radiation units in addition to the first radiation unit 120 and the second radiation unit 140. When the first radiation unit 120 is a Wi-Fi radiation unit, a third radiation unit 160 may be further included in order to increase the radiation characteristics of the Wi-Fi signal. The number and shape of radiation units formed in the antenna module 100 may vary depending on the design of the antenna module. The radiation patch of the third radiation unit 160 may have a different lengthwise direction from the radiation patch of the first radiation unit 120. As shown in FIG. 2, in addition to the first radiation unit 120 and the second radiation unit 140, a third radiation unit 160 may be formed on the substrate 150, and at this time, the third radiation unit 160 may be a Wi-Fi radiation unit together with the first radiation unit 120. In forming the third radiation unit 160, it may be formed to be spaced apart from the first radiation unit 120 at a predetermined interval, and in order to reduce interference between radiation units, the lengthwise directions of the radiation patches may be formed to be different from one another.

The third radiation unit 160 may include a radiation patch, at least one feed portion, and at least one support portion. As an example, as shown in FIG. 13, the radiation patches may be formed adjacent to the first radiation unit 120, but the lengthwise directions of the radiation patches may be different from one another. The third radiation unit 160 may be a PIFA antenna, or may be various antennas such as a helical antenna, a monopole antenna, and an SMD antenna.

A communication module chip 211 may be disposed on the substrate 150. As shown in FIG. 13, the communication module chip 211 may be disposed on the substrate 150 and may be a chip including a processor that controls signals required for communication to be performed by the antenna module 100. The communication module chip 211 can perform various functions required for communication.

An electronic device according to an embodiment of the present invention includes: a first radiation unit being disposed on a substrate and to which current is applied through a first feed pattern; and a second radiation unit being disposed on the substrate and spaced apart from the first radiation unit, and to which a current is applied through a second feed pattern, wherein the phases of radiating signals of the first radiation unit and the second radiation unit are different. A detailed description of the antenna module comprising a first feed pattern, a first radiation unit, a second feed pattern, and a second radiation unit being included in the electronic device according to an embodiment of the present invention corresponds to the detailed description of the antenna module 100 for FIGS. 1 to 13.

The electronic device according to an embodiment of the present invention is applicable to various types of devices having communication functions, and for example, it can be applied to various devices including antenna modules, such as TVs (especially smart TVs), monitors, PDAs, PCs, laptops, mobile terminals, smart terminals, and navigation devices, and other than these, it can be applied to various types of devices including communication functions.

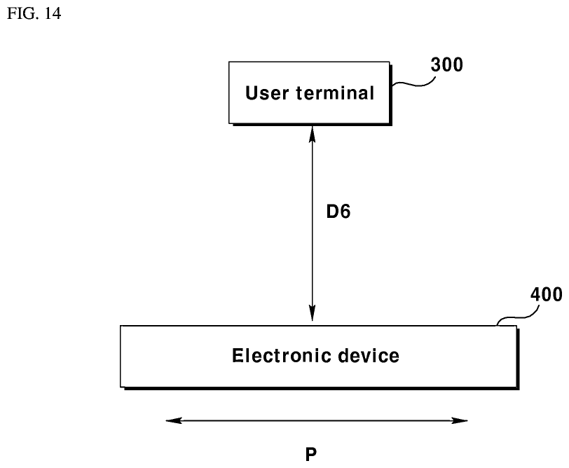

The electronic device can secure wireless performance by minimizing transmission rate degradation through a signal interference exclusion structure even if the first radiation unit and the second radiation unit include adjacent ultra-small antenna modules. FIG. 14 shows a case of measuring the data transfer rate of the electronic device 400 when the user terminal 300 is spaced apart from the user terminal 300 by a predetermined distance D6, and in the case of including the first feed pattern and the second feed pattern, which are signal interference exclusion structures, and in the case of not including the first feed pattern and the second feed pattern, which are signal interference exclusion structures, the data transfer rate is as follows. D6 is 3 m, and is the result of measuring the Wi-Fi data transmission rate during Bluetooth operation at a weak electric field of −78 dBm, and at the position of the user terminal 300 from −30 to +30 cm from 0 cm which is the center.

TABLE 1

| Without signal interference | | With signal interference | |
|---|---|---|---|
| exclusion structures | | exclusion structures | |
| Position | Data transmission rate | Position | Data transmission rate |
| −30 | 19 | −30 | 31 |
| −20 | 15 | −20 | 28 |
| −10 | 20 | −10 | 32 |
| 0 | 22 | 0 | 36 |
| 10 | 22 | 10 | 34 |
| 20 | 16 | 20 | 34 |
| 30 | 15 | 30 | 36 |

In the case where the signal interference exclusion structure is not included, the specification of at least 25 Mbps is not satisfied, whereas in the case where the signal interference exclusion structure is included, it can be confirmed that the minimum specification of 25 Mbps is satisfied in any case. Through this, compared to the case of not including a signal interference exclusion structure that requires maintaining a separation of at least 28 mm or more, it is possible to implement an ultra-small antenna module by preventing performance deterioration even if the separation distance is as short as 5.7 mm. As described above, the present invention has been described with specific details such as specific components and limited embodiments and drawings, but this is only provided to facilitate a more general understanding of the present invention, and the present invention is not limited to the above embodiments, and therefore, those skilled in the art can make various modifications and variations of the position measuring unit based on this description.

Accordingly, the spirit of the present invention should not be limited to the described embodiments, and the scope of the patent claims being described hereinafter as well as all things that are equivalent or equivalent to the scope of this patent claim shall fall within the scope of the spirit of the present invention.

1. An antenna module comprising:
a first radiation unit disposed on a substrate and applied with a current through a first feed pattern; and
a second radiation unit spaced apart from the first radiation unit, disposed on the substrate and applied with a current through a second feed pattern,
wherein phases of signals radiated by the first radiation unit and the second radiation unit are different,
wherein the substrate comprises a plurality of layers,
wherein the first feed pattern comprises:
an input end and an output end; and
a first pattern unit connecting between the input end and the output end, and
wherein the first pattern unit is formed on at least some of the plurality of layers of the substrate;
wherein the substrate comprises four layers, and
wherein the first pattern unit is formed on the four layers and connected to one another in parallel.

2. The antenna module according to claim 1,
wherein the first radiation unit and the second radiation unit have a phase difference of 90 degrees.

3-10. (canceled)

11. The antenna module according to claim 1,
wherein first pattern units formed on the plurality of layers of the substrate are connected to one another through a via hole formed at the input end and the output end.

12. The antenna module according to claim 1,
wherein the length of the first pattern unit connected between the input end and the output end is 4.5 to 6.5 mm.

13. The antenna module according to claim 1,
wherein the substrate comprises a plurality of layers, and
wherein the second feed pattern comprises:
an input end and an output end;
a second pattern unit connecting the input end and the output end and formed on some of the plurality of layers of the substrate; and
a third pattern unit not connected to the input end and the output end and formed on layers different from the second pattern unit among the plurality of layers of the substrate.

14. The antenna module according to claim 13,
wherein the third pattern unit is formed on an upper side and a lower side of the layer where the second pattern unit is formed.

15. The antenna module according to claim 14,
wherein the third pattern unit formed on the upper side and the lower side of the layer where the second pattern unit is formed is connected to one another through a via hole.

16. The antenna module according to claim 13,
wherein the length of the second pattern unit connected between the input end and the output end is 8.2 to 10.2 mm.

17. The antenna module according to claim 13,
wherein the second pattern unit is formed in a meander shape.

18. The antenna module according to claim 13,
wherein the substrate includes four layers,
wherein the second pattern unit comprises:
a second layer pattern formed in the second layer and connected to the input end and the output end through a via hole; and
a fourth layer pattern formed in the fourth layer and connected to the central area of the second layer pattern through a via hole,
wherein the third pattern unit comprises:
a first layer pattern formed in the first layer and not electrically connected to the input end and the output end; and
a third layer pattern connected to the first layer pattern through a via hole and formed in the third layer.

19. The antenna module according to claim 13,
wherein the third pattern unit is spaced apart from the second pattern unit to form capacitance.

20. The antenna module according to claim 1,
wherein a length of a radiation patch of the first radiation unit is 12.8 to 13.2 mm.

21. The antenna module according to claim 1,
wherein the first radiation unit comprises a first radiation patch and a second radiation patch,
wherein a length of the first radiation patch is 12.8 to 13.2 mm, and
wherein the length of the second radiation patch is 3.8 to 4.2 mm.

22. The antenna module according to claim 1,
wherein a length of the radiation patch of the second radiation unit is 13.8 to 14.2 mm.

23. The antenna module according to claim 1,
wherein one of the first radiation unit and the second radiation unit is a radiation unit for Wi-Fi, and the other is a radiation unit for Bluetooth.

24. The antenna module according to claim 1, comprising:
a third radiation unit disposed on the substrate and spaced apart from the first radiation unit and the second radiation unit,
wherein a phase of a signal radiated from the third radiation unit is different from that of the first radiation unit and the second radiation unit.

25. The antenna module according to claim 24,
wherein the third radiation unit has a phase difference of 90 degrees from the first radiation unit, and a phase difference of 180 degrees from the second radiation unit.

26. An antenna module comprising:
a first radiation unit disposed on a substrate and applied with a current through a first feed pattern; and
a second radiation unit spaced apart from the first radiation unit, disposed on the substrate and applied with a current through a second feed pattern,
wherein phases of signals radiated by the first radiation unit and the second radiation unit are different,
wherein the substrate comprises a plurality of layers, and
wherein the second feed pattern comprises:
an input end and an output end;
a second pattern unit connecting the input end and the output end and formed on some of the plurality of layers of the substrate; and
a third pattern unit not connected to the input end and the output end and formed on layers different from the second pattern unit among the plurality of layers of the substrate.

27. The antenna module according to claim 26,
wherein the third pattern unit is formed on an upper side and a lower side of the layer where the second pattern unit is formed.

28. An electronic device, comprising the antenna module according to claim 1.
